(19) United States
(12) Patent Application Publication
(10) Pub. No.: US 2024/0394731 A1
(43) Pub. Date: Nov. 28, 2024

(54) Participation Momentum Feed

(71) Applicant: Angel Studios, Inc., Provo, UT (US)

(72) Inventor: Jeffrey Harmon, Provo, UT (US)

(21) Appl. No.: 18/622,843

(22) Filed: Mar. 29, 2024

Related U.S. Application Data
(60) Provisional application No. 63/455,455, filed on Mar. 29, 2023.

(51) Int. Cl. G06Q 30/0201; G06Q 50/00

(52) U.S. Cl. CPC G06Q 30/0201; G06Q 50/01

(57) ABSTRACT

A participation momentum feed may comprise presenting an online interface for purchase tickets to a movie and, in conjunction with such interface, additionally presenting a feed showing pending or completed transactions for others to purchase tickets to the same movie.

### CROSS-REFERENCE TO RELATED APPLICATIONS

This application claims priority to U.S. provisional application No. 63/455,455, titled “Participation Momentum Feed,” the first inventor of which is Jeff Harmon, which was filed on Mar. 29, 2023, and which is incorporated by reference herein in its entirety.

### BACKGROUND OF THE INVENTION

People are constantly looking to be part of a community. It is part of why social media is such a popular aspect of today's culture. However, the Internet can be socially sterile. In many environments on the Internet a user is unaware or has only limited information about how many other individuals are (or have) viewing the same content, reviewing a product, purchasing a product, engaging with a specific social media post, and/or other types of Internet activity/participation.

This contrasts with brick-and-mortar stores, in which passersby can quickly and easily tell how popular a store is by the number of people there. For example, in a mall environment a store with a long line would indicate that it is very popular for the goods being sold. Alternatively, a visibly limited or low stock of any item can be an indicator of popularity and desirability.

What is needed is an improved system and method for apprising Internet users (or users of other networks) of activity similar to the activity the user is currently engaged in or in which the user is considering becoming engaged.

### BRIEF DESCRIPTION OF THE DRAWINGS

FIG. 1 shows an exemplary web platform interface that includes a participation momentum feed as described herein.

FIG. 2 shows an exemplary participation momentum feed as described herein.

FIG. 3 shows an exemplary participation momentum feed as described herein.

FIG. 4 shows an exemplary contextual area of a participation momentum feed as described herein.

FIG. 5A shows an exemplary participation momentum feed as described herein at a time t₁.

FIG. 5B shows an exemplary participation momentum feed as described herein at a time t₂.

FIG. 5C shows an exemplary participation momentum feed as described herein at a time t₃.

FIG. 6 shows a flowchart for an exemplary method as described herein.

### DETAILED DESCRIPTION OF THE INVENTION

A system and method are disclosed for a participation momentum feed.

Table of Reference Numbers from Drawings:

The following table is for convenience only and should not be construed to supersede any potentially inconsistent disclosure herein.

| Reference Number | Description |
|---|---|
| 100 | exemplary interface |
| 200 | exemplary participation momentum feed |
| 210 | tracking bar |
| 220 | media interface |
| 230 | contextual area |
| 231 | collectible scene indication |
| 300 | flowchart for exemplary method |
| 310 | step in flowchart 300 |
| 320 | step in flowchart 300 |
| 330 | step in flowchart 300 |
| 340 | step in flowchart 300 |

A participation momentum feed may be used in many applications. A feed may be used to promote a community through ticket sales, investments, merchandise sales, and many more applications. As used herein, “activity” is construed broadly to include many activities that occur via the Internet (or other networks with comparable functionality for the scope of the disclosure herein).

For example, Internet activity may include, but is not limited to, viewing a movie trailer; viewing other content; listening to content; shopping for products or services; purchasing tickets for events (e.g., movies, concerts, plays, operas, etc.); trading items such as stocks, cryptocurrency, etc.; viewing/engaging in social media; livestream events; investing in enterprises, exploring/researching/considering Internet activities; and video calls.

### Ticket Sales

In one embodiment, Internet activity may comprise viewing a movie trailer, viewing/browsing a website/interface about the movie, and/or viewing/browsing an interface for potential purchase of tickets for the movie. In conjunction with such Internet activity, an interface may be presented (e.g., from a web server and transmitted or otherwise presented to the interface/website/app with which a viewer/user is interacting) that shows a feed of participation with the movie. Such participation may comprise, e.g., a user interaction by clicking on a button or otherwise to explore (get more information on) purchase of tickets, begin purchasing tickets (e.g., click a link/button and get redirected to a ticket-purchase website/app), or taking actions in the process of purchasing tickets, or finalizing purchase of tickets for the movie.

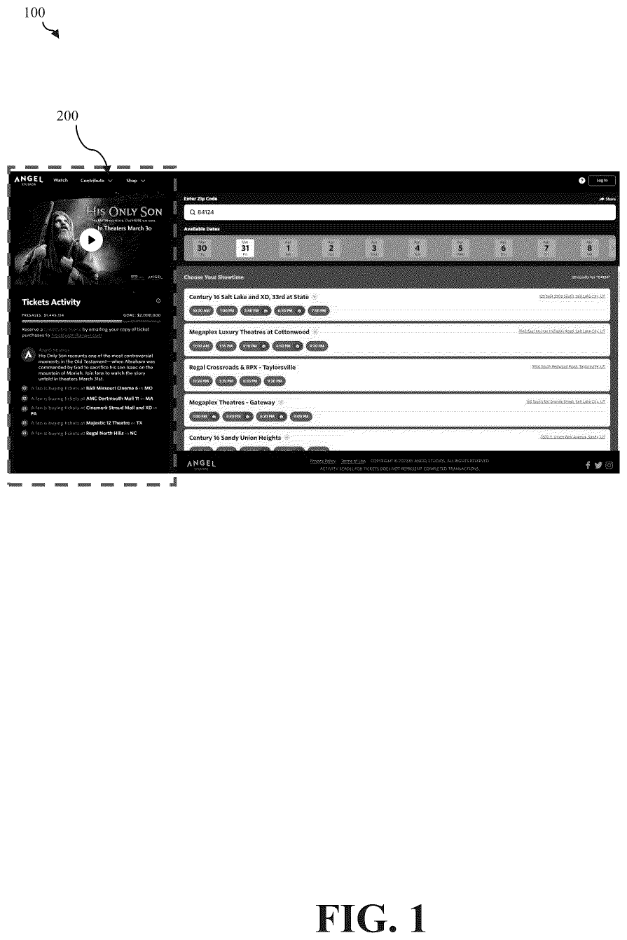

As shown in FIG. 1, participation momentum feed 200 may be part of a larger web platform 100. FIG. 1 shows a movie ticket sales platform for a movie titled “His Only Son.” The participation momentum feed may update in real time. As shown in FIG. 1, the participation feed may provide real-time notifications of other individuals (or Internet users) purchasing tickets for the movie “His Only Son.” As shown in FIG. 1, each entry/update in the participation feed may comprise text reporting that “[a] fan is buying tickets at [theater name] in [U.S. State].”

A participation momentum feed 200 may include a media interface 220. The media interface 220 may show a movie trailer. In another embodiment, the media interface 220 may provide a background or director's comments on the filming and/or creation of the movie or other promotional materials. The interface may present other information or media about the movie.

A participation momentum feed 200 may include a tracking bar 210 (or other visual or textual depiction reflecting a metric of sales or other participation). In one embodiment, the tracking bar 210 is for the total number of tickets that are available for an event. In an alternative embodiment the tracking bar 210 may illustrate the money earned or raised through the event. In another embodiment the tracking bar may indicate a target number for quantity of ticket sales and/or money amount of ticket sales, as well as progress toward such target.

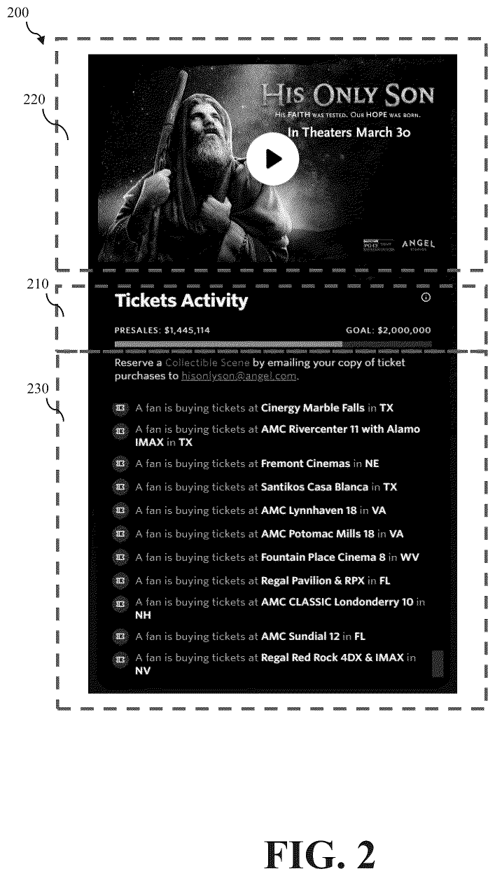

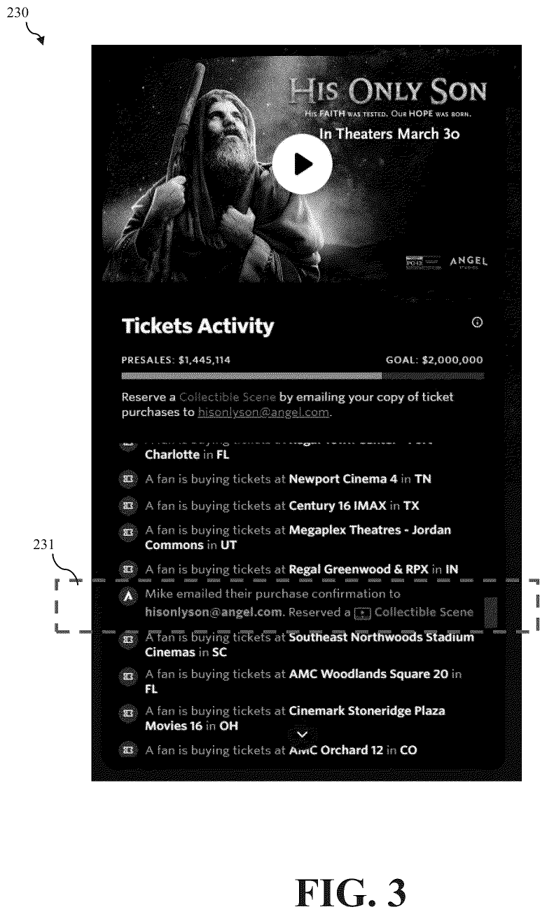

A participation momentum feed 200 may include a secondary option or task that may be completed by users. For example, user may “Reserve a Collectible Scene by emailing your copy of ticket purchases to hisonlyson@angel.com.” As shown in FIGS. 1-3. Here a collectible scene is the opportunity to have a special interest in a segment of the scene or movie. In FIG. 3, a user, “Mary,” emailed a copy of her ticket confirmation to hisonlyson@angel.com and “Reserved a Collectible Scene” ref. no. 231.

In general, many different types of participation may be reported by a participation momentum feed, and many different types of participation may be solicited/prompted in conjunction with the participation momentum feed. For example, participation reported by a participation momentum feed may comprise, but is not limited to: purchasing tickets; reviewing tickets; posting on social media; providing an email address; connecting through social media (e.g., “Bill from Fort Lauderdale just accepted a connection request for Jim Fridssan on LinkedIn”); acquiring an interest in an NFT or other item, purchasing a physical item, viewing content (e.g., “Bill from Fort Lauderdale just viewed this video”); investing in a project or enterprise (e.g., “15 minutes ago Bill from Fort Lauderdale invested $1,000 in this project”); commenting/posting on a restaurant, venue, location, service, product; etc.

Many different types of participation may be solicited/prompted in conjunction with the participation momentum feed. In general, the solicited/prompted participation may be the same items listed above for the reported participation. But the participation solicited/prompted in conjunction with a participation momentum feed is not necessarily the same participation that is reported in the participation momentum feed. For example, a participation momentum feed may report views of a movie trailer, but the solicited/prompted participation may comprise purchasing tickets for the movie and/or purchasing NFTs associated with the movie.

A participation momentum feed 200 may also be used for a smaller or more limited platform. For example, a movie theater may have a participation momentum feed 200 on their main webpage for ticket sales. The participation feed 200 may identify “a fan bought 10 tickets for the Mar. 30, 2023 6:10 pm showing of Star Wars,” and “a fan bought 3 tickets to Mar. 30, 2023 2:00 pm showing of Frozen.” The participation feed 200 can show a user which tickets and/or movies are popular for their local theater.

### Investments

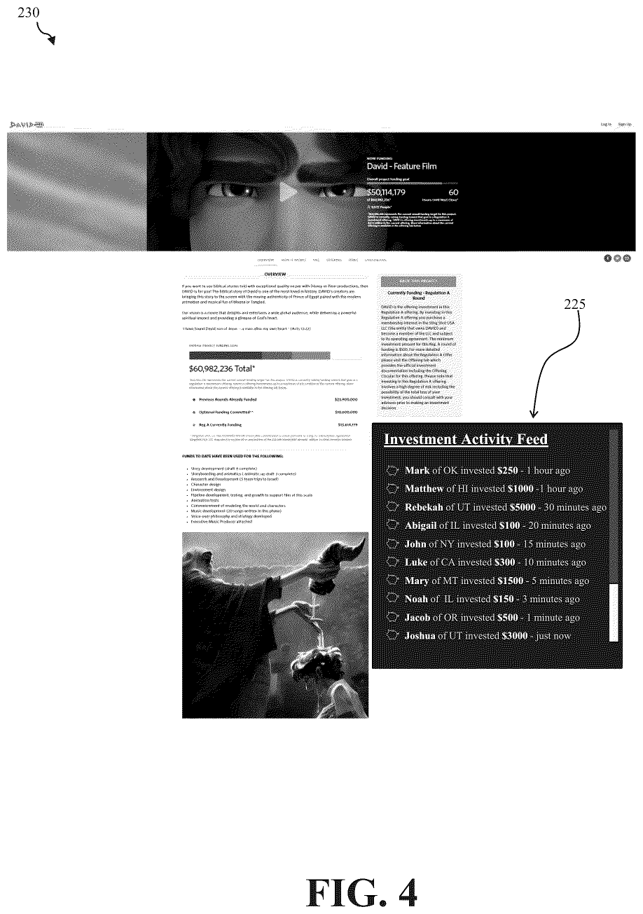

In another embodiment, the participation momentum feed 200 may be used to track investments. A participation momentum feed 200 may be used to track the trade of popular stock. Alternatively, the feed 200 may be used to track the investments of others for a crowdfunding project. For example, FIG. 4 shows an exemplary participation momentum feed 225 for an investment activity—in this case, investing in a project to make a movie.

### Tracking

A participation momentum feed 200 may be permanently available or available only during the period the webpage, or host platform, is showing. For example, in FIG. 1 the participation momentum feed 200 may be blank when the user first accesses the platform 100. The feed 200 will then populate with participation events as the platform 100 remains open on the device. Once the platform 100 closes, or a new session is started, the feed 200 resets and will only show the new participation events.

In an alternative embodiment, the participation feed 200 has a more permanent structure. The feed 200 does not begin until the participation window opens. An example of this may be used for a live music concert ticket sale. The ticket sales platform would include a participation momentum feed 200. Prior to the ticket sale window opening, the participation momentum feed 200 has no results. Once ticket sales open to the public, participation events would begin to populate the participation momentum feed 200. In this embodiment, a user can close the platform and start a new session, but the participation event feed 200 would be the same feed as if the user had never closed the window. A benefit to this method is it would give users information about how many people have bought tickets since the sale window opened.

For some events, the full participation momentum feed 200 history may be long or substantial. In an alternative embodiment, the participation momentum feed 200 may be limited to providing the past participation events occurring five minutes prior to opening the platform.

In another embodiment, the participation feed 200 may save only the participation event history of ten minutes and the participation feed 200 would save over itself after the ten-minute mark. This would limit the amount of server space needed to provide the feed 200 to users. The ten-minute time suggestion is arbitrary; the time limit could as easily be 60 seconds, two hours, or two days.

The temporal scope of the participation entries shown in a participation momentum feed may be adjusted based on circumstances or problem-domain factors. For example, if participation events are not occurring every few seconds, it may be useful to pre-populate the participation momentum feed display with participation events from some period of time prior to the time when a user/view accessed the participation momentum feed or when the participation momentum feed was shown to the user.

In another embodiment, the participation momentum feed 200 includes a tracking or status bar 210 above the contextual area 230 of the participation momentum feed 200. The tracking bar 210 includes some indicator of the goal, purpose, or availability of the event. For a live concert, the tracking bar 210 may illustrate the number of seats available in the desired venue. As the tracking bar 210 grows in length, or height, the number of remaining available seats is dwindling. For charity events, the tracking bar 210 may be fundraising goal. In some cases, the tracking bar 210 may extend farther than the goal amount to illustrate the additional money raised.

### Geography

A participation momentum feed 200 may have many advantages. For example, companies with a national or international footprint may cater their feed to particular regions. The participation momentum feed 200 may present only the participation events of individuals living in a particular geographic region, for example a 50-mile radius from the user. These geographically limited feeds illustrate the community dynamics and create a community of like-minded individuals.

Alternatively, feeds 200 may be limited geographically by state or even country depending on the needs of the platform owner.

### Demographics

In another embodiment, the participation momentum feed 200 may be filtered to show the demographics or by demographics. For example, if the participation momentum feed 200 platform was a user profile-based system, the system may have identified key demographic features of the users. The participation momentum feed 200 would then show or record the participation events of the users having a similar demographic to the viewer.

In general, the participation events shown or presented in the participation momentum feed may be filtered by time, geography, demographics, participation level (e.g., showing only donations over $100), etc.

### Social Media Use

In some embodiments, a participation momentum feed 200 may be used in an advertisement on social media. Rather than traditional comments, a participation momentum feed 200 may be used to promote an event coming to the geographic region. For example, a music video montage of Taylor Swift's most popular hits may have a pop-up ad for her new concert tour. A participation momentum feed 200 will show the number of tickets being sold at that moment and may include information about the going rate.

Alternatively, a participation momentum feed 200 may be a constant feature on a media platform and inform users of the company sponsoring the ad, e.g., “ad from Target just started.”

### Alternative Uses

A participation momentum feed 200 may be used to create a community of users interested in an event. Alternatively, a participation momentum feed 200 may be used to educate individuals on commercial transactions. For example, users new to particular environment can view recent transactions and understand the value of the items being purchased.

A participation momentum feed 200 may be simple and generic or may provide vast amounts of detailed information to the users. More detailed information may be available by clicking on a link or icon to learn more about the purchased item.

### Context

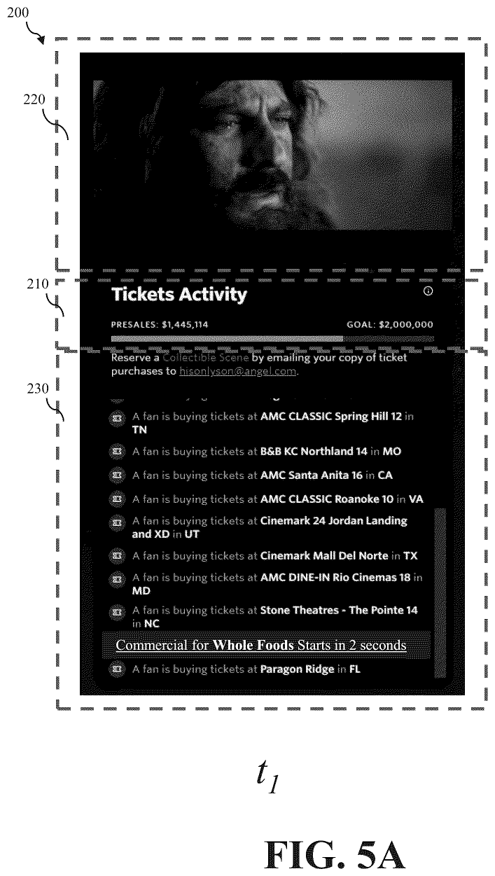

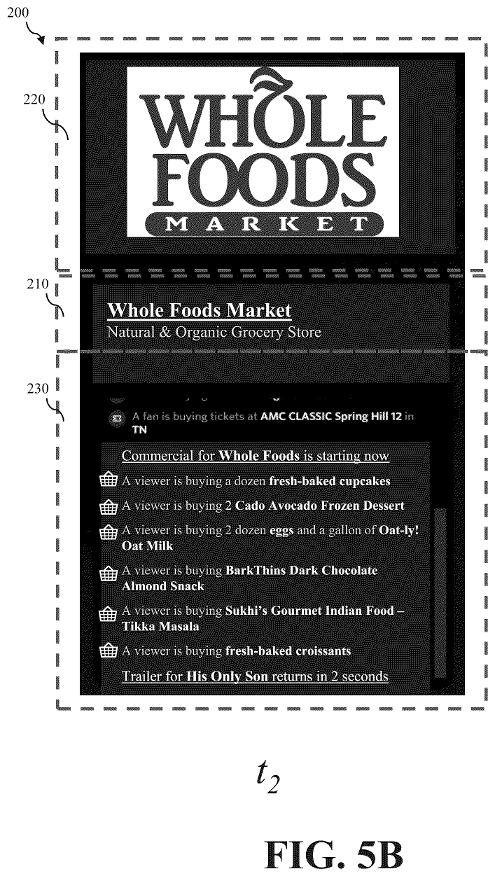

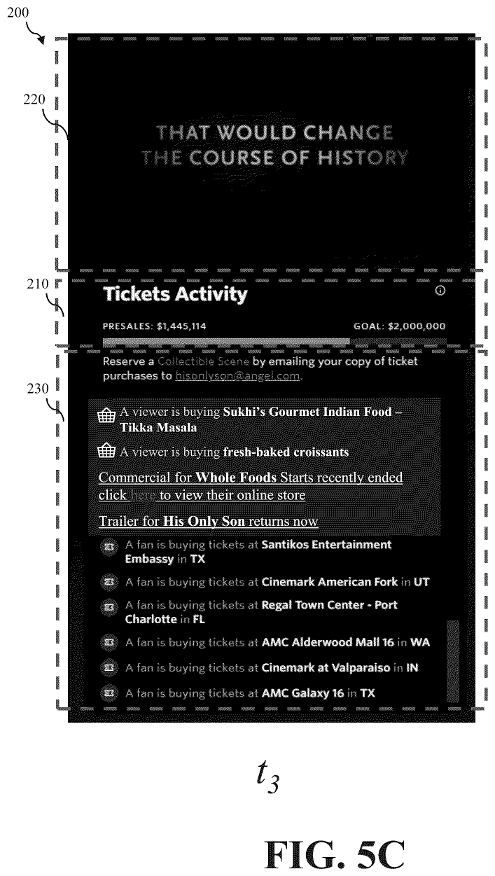

In some embodiments, the participation events shown in a participation momentum feed may be context sensitive. For example, if a commercial/advertisement is shown during content (e.g., an advertisement is shown during a movie or trailer for a movie), the same participation momentum feed may be used to present participation for the trailer and for the advertisement. FIGS. 5A, 5B, and 5C show an exemplary embodiment in which the same participation momentum feed 230 is used for both a movie trailer and an advertisement shown during the movie trailer. At time t₁ in FIG. 5A, a movie trailer for His Only Son is being shown in media interface 220 and at the same time t₁ participation momentum feed 230 is showing participation events for purchasing tickets to see His Only Son. For the sake of clarity, a solicitation/prompt to purchase tickets would likely be presented in conjunction with the interface shown in FIGS. 5A and 5C, e.g., as shown in FIG. 1. FIGS. 5A and 5B show a cropped close-up view that does not show the prompt solicitation to purchase tickets.

At time t₂ in FIG. 5B, an advertisement for the grocery store Whole Foods is being shown in media interface 220 and at the same time t₂ participation momentum feed 230 has transitioned to feeding participation events for purchasing items from Whole Foods.

At time t₃ in FIG. 5C, the advertisement for Whole Foods has ended and media interface 220 is again showing the movie trailer for His Only Son, and in conjunction with switching back to the movie trailer for His Only Son, at the same time t₃ participation momentum feed 230 is again feeding participation events for purchasing tickets to see His Only Son.

The participation events discussed and described herein above may be stored on and accessed by servers and databases as is known in the art. Electronic devices used by a viewer/consumer for viewing a participation momentum feed and/or following a participation solicitation/prompt may include a smartphone, tablet, laptop, desktop, and/or any other electronic computing device known in the art.

As described herein relative to movies and/or other live events, purchasing a ticket may require a theater or other venue to allow a user/viewer to enter and view the movie or other event.

### Methods

An exemplary method may comprise: (1) presenting to a user/viewer an interface for purchasing tickets to a live event, e.g., a movie showing; (2) in conjunction with presenting the interface for purchasing tickets to a live event, additionally presenting a participation momentum feed showing other time-correlated purchases of tickets for the movie; (3) receiving an indication from the user/viewer of a desire to purchase tickets for the movie; and (4) consummating a transaction to sell tickets for the movie to the user/viewer.

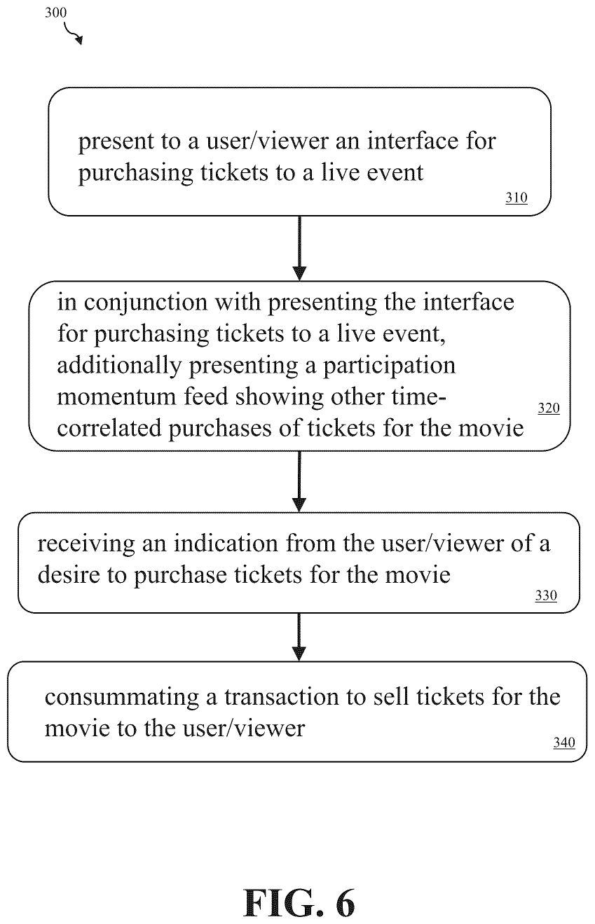

FIG. 6 shows a flowchart for an exemplary method 300. At step 310, an interface for purchasing tickets to a live event, e.g., a movie showing, may be presented to a user/viewer. At step 320, in conjunction with presenting the interface for purchasing tickets to a live event, a participation momentum feed showing other time-correlated purchases of tickets for the movie may be additionally presented. At step 330, an indication of a desire to purchase tickets for the movie may be received from the user/viewer. At step 340, a transaction to sell tickets for the movie to the user/viewer may be consummated.

What is claimed is:

1. A computer-implemented method, comprising:
remotely and electronically presenting an interface for engaging in a remote computer activity;
in conjunction with presenting the interface for engaging in a remote computer activity, remotely and electronically presenting a participation momentum feed.

2. The method of claim 1, wherein the remote computer activity comprises at least one from the following list: consuming audiovisual content, consuming visual content, consuming audio content, shopping, purchasing tickets, trading economic assets, and social media.

3. The method of claim 2, wherein the remote computer activity comprises purchasing a performance ticket.

4. The method of claim 3, wherein the performance ticket is a ticket for a movie.

5. The method of claim 4, wherein the remote computer activity further comprises watching a trailer for the movie.

6. The method of claim 4, wherein the participation momentum feed comprises a time-updated feed comprising information about others who have purchased or are purchasing a ticket for the same movie.

7. The method of claim 6, wherein the time-updated feed is a real-time feed.

8. The method of claim 6, wherein the participation momentum feed comprises at least one from the following list: a number of tickets available for the movie, an amount of money spent on purchasing tickets for the movie, and a target for ticket sales for the movie.

9. The method of claim 4, wherein the participation momentum feed comprises information for at least one other person for the movie for at least one from the following list: purchasing tickets, reviewing the movie, posting on social media, providing an email address, connecting through social media, acquiring an interest in an NPT, and purchasing a physical item.
